(19) United States
(12) Patent Application Publication
(10) Pub. No.: US 2021/0267163 A1
(43) Pub. Date: Sep. 2, 2021

(54) FEEDING GLOVE

(71) Applicant: Kathryn Robinson, Lewes, DE (US)

(72) Inventor: Kathryn Robinson, Lewes, DE (US)

(21) Appl. No.: 16/803,983

(22) Filed: Feb. 27, 2020

(51) Int. Cl. A01K 9/00

(52) U.S. Cl. CPC A01K 9/00

(57) ABSTRACT

An illustrated view of a feeding system for assisting young animals in nursing and feeding is presented. The feeding system mimics the look, feel and size of the mother's natural nipples or teats. Also, the feeding system is useful for feeding from one (1) to four young animals, such as, but not limited to, dogs, cats, gerbils, sheep, etc. The feeding system is useful for veterinarians, animal rescue centers, breeders, zoos, etc. The feeding system is useful for encouraging instinctual feeding and provides comforting natures of a warm human touch.

### FIELD OF THE INVENTION

This invention relates to animals. More particularly, it relates to a feeding system for young animals.

### BACKGROUND

Animals are multicellular eukaryotic organisms that form the biological kingdom Animalia. With few exceptions, animals consume organic material, breathe oxygen, are able to move, can reproduce sexually, and grow from a hollow sphere of cells, the blastula, during embryonic development. Over 1.5 million living animal species have been described—of which around 1 million are insects—but it has been estimated there are over 7 million animal species in total. Animals range in length from 8.5 millionths of a meter to 33.6 meters (110 ft). They have complex interactions with each other and their environments, forming intricate food webs. The kingdom Animalia includes humans, but in colloquial use the term animal often refers only to non-human animals. The study of non-human animals is known as zoology.

Humans make use of many other animal species, such as for food (including meat, milk, and eggs), for materials (such as leather and wool), and also as pets, and for transports, as working animals. Dogs have been used in hunting, while many terrestrial and aquatic animals were hunted for sports. Non-human animals have appeared in art from the earliest times and are featured in mythology and religion.

When baby or small animals are either unable to be nursed by their mother or are not able to receive nourishment in the normal manner, many ways to feed the baby animal have been undertaken with a variety of results. One of the major problems is feeding more than one animal at a time.

In light of the foregoing, it would be desirable to devise a feeding glove system for use with kittens, puppies and similar animals that mimics the look, feel and size of the animal's mother's natural teats. It would be further advantageous if the device were more comfortable, easy to use and disposable to provide comfort, care and a hygienically clean system for aid in feeding young animals.

### BRIEF DESCRIPTION OF THE DRAWINGS

FIG. 1 is an illustrated view of a feeding system.

FIG. 2 is an illustrated view of bottles coupled to the feeding system shown in FIG. 1.

FIG. 3 is an illustrated use of the feeding system shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

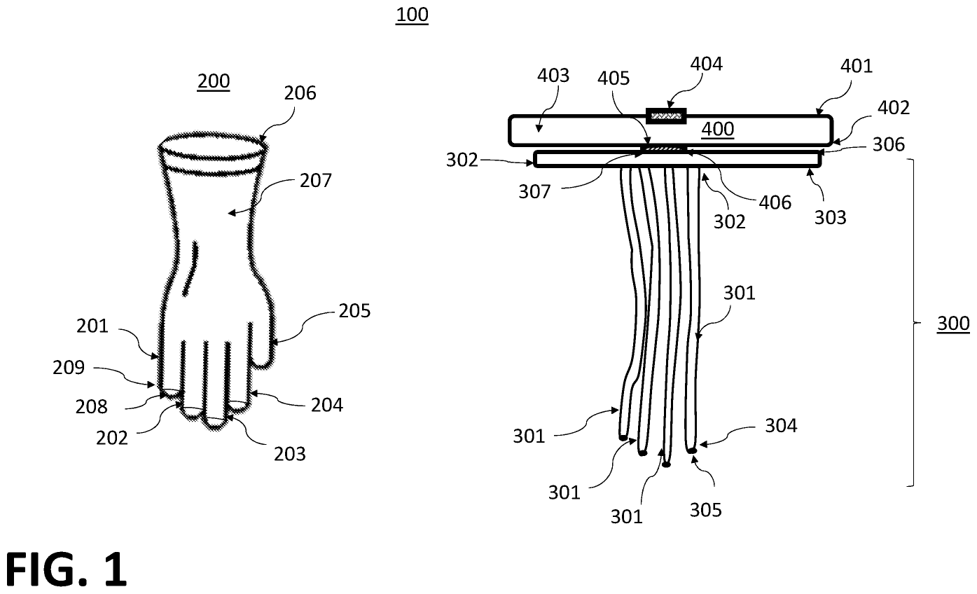

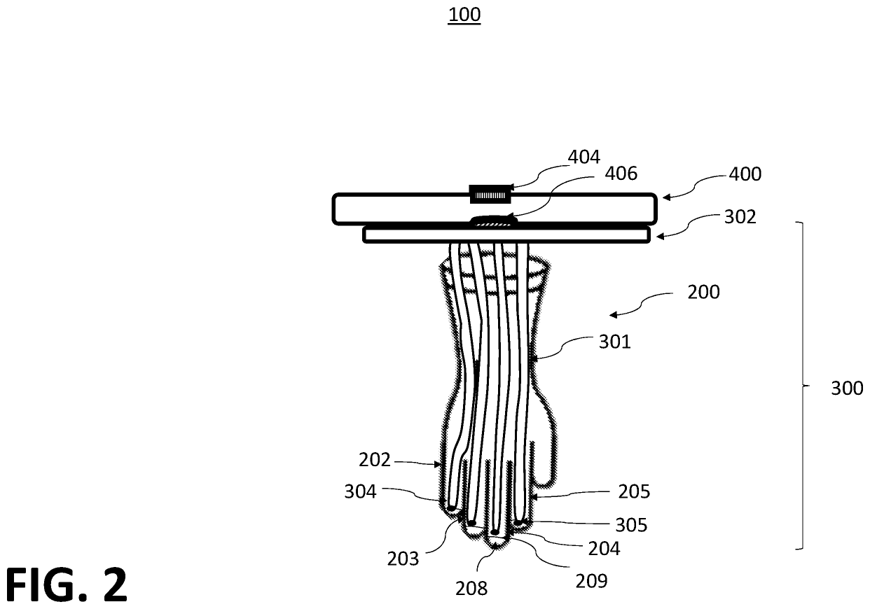

Referring to FIG. 1 and FIG. 2, an illustrated view of a feeding system 100 for assisting young animals in nursing and feeding is presented. The feeding system 100 mimics the look, feel and size of the mother's natural nipples or teats. Also, the feeding system 100 is useful for feeding from one (1) to four (4) young animals, such as, but not limited to, dogs, cats, gerbils, sheep, horse etc. The feeding system 100 is useful for veterinarians, animal rescue centers, breeders, zoos, etc. The feeding system 100 is useful for encouraging instinctual feeding and provides comforting natures of a warm human touch.

The feeding system 100 has a feeding glove 200, a tubing assembly 300 and a feeding container 400. The feeding glove 200 is preferably made of a latex material, however other materials are hereby contemplated, including, but not limited to, soft-plastic, nylon, rubber, etc. The feeding glove 200 is preferably non-disposable but may be disposable if so desired.

The feeding glove 200 has a plurality of finger channels 201, 202, 203, 204, a thumb channel 205, a top 206 and an interior 207. Each of the finger channels 201, 202, 203, 204 have an orifice 208 at the tip 209 of each of the finger channels 201,202, 203, 204, the orifice 208 for allowing liquid to egress from the feeding glove 200.

The tubing assembly 300 of the feeding system 100 has a plurality of tubes 301 and a distributing tube 302. The plurality of tubes 301 is preferably four (4) in number, however other number of tubes is hereby contemplated, including, but not limited to, three (3), five (5), etc. The tubes 301 are preferably made of a disposable material, however the material may be reusable.

A top of the tubes 301 is removably coupled to a bottom 303 of the distributing tube 302 such that a liquid contained in the distributing tube 302 is distributed to the tubes 301. The tubes 301 are preferably hollow. A top 306 of the distributing tube 302 has an opening 307.

A tip 304 of the tubes 301 preferably have an orifice 305. The orifice 305 provides an egress for the liquid received at the top of the tubes 301.

The feeding container 400 has a top 401, a bottom 402 and an interior 403. The top 401 has an opening 404 such that liquid nutrition may be poured or enter into the interior 403 of the feeding container 400. The feeding container 400 is preferably a feeding bag, container, bottle, etc.

The bottom 402 of the feeding container 400 has an opening 405. A valve 406 is coupled to the opening 405 of the bottom 402. The valve 406 is preferably a pressure valve, however other types of valves are hereby contemplated, including, but not limited to, pinch valve, actuatable valve, etc.

The valve 406 coupled to the opening 405 of the bottom 402 is coupled to the opening 307 of the top 306 of the distributing tube 302.

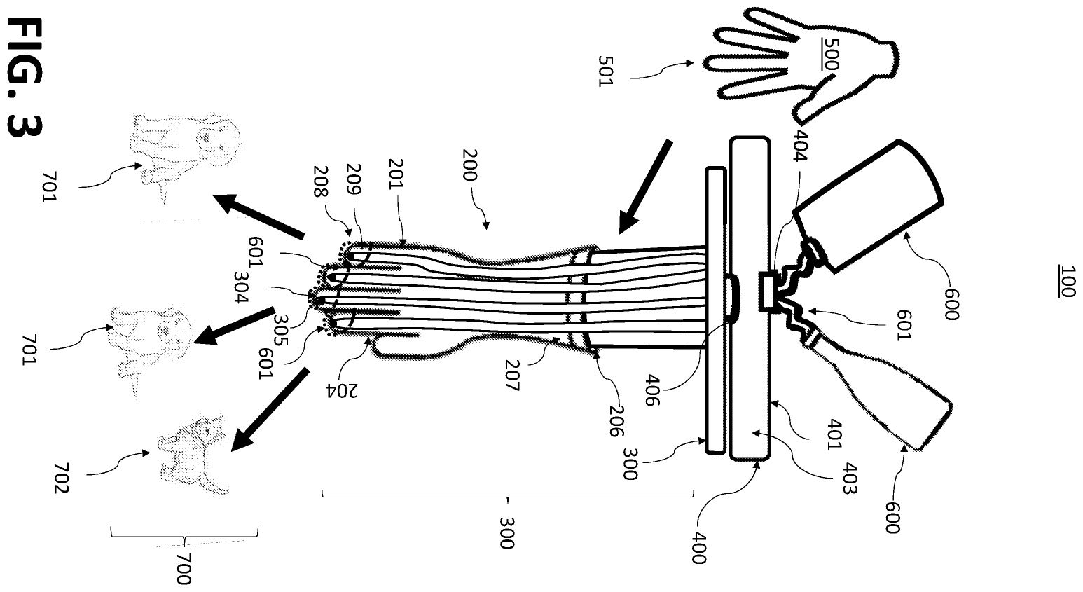

Moving now to FIG. 3, an illustrated view of a use of the feeding system 100 shown in FIG. 1, and further shown in FIG. 2, is presented.

A person places their hand 500 into the feeding glove 200 of the feeding system 100. The tubes 301 are each placed into one of the finger channels 201, 202, 203, 204. The liquid nutrient 601 contained in liquid containers 600 are poured into the opening 404 in the top 401 of the feeding container 400. The liquid nutrient 601 is stored in the interior 403 of the feeding container 400.

Each finger 501 of the hand 500 of the person enters the mouth of the animals 700, such as a puppy 701, kitten 702, etc. The tubes 201, 202, 203, 204 are pressured and actuate the valve 406 to release liquid nutrient 601 to the distributing container 300 and released to the tubes 201, 202, 203, 204. The liquid nutrient 601 flows into the mouth of the animals 700 and when feeding has completed, the finger of the person is removed from the mouth of the animal, thus relieving pressure and de-actuation of the valve 406 to prevent the liquid nutrient 601 from being released from the feeding container 400.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A feeding system for assisting young animals in nursing and feeding, the system comprising:
a feeding glove, the feeding glove having a plurality of finger channels, a top and an interior, wherein each of the finger channels having a tip and an orifice, wherein the orifice being an opening at the tip of the finger channels;
a tubing assembly, the tubing assembly comprising:
a plurality of tubes, each of the plurality of tubes having a top and a tip, wherein the tip having an orifice;
a distributing tube, the distributing tube having a top and a bottom, wherein the top having an opening, and wherein the bottom being removably coupled to the top of the plurality of tubes; and
a feeding container, the feeding container having a top, a bottom and an interior, wherein the interior being for containing a nutrient liquid, wherein the top having an opening, and wherein a valve coupled to an opening in the bottom of the feeding container, and wherein the valve being communicatively coupled to the opening of the top of the distributing tube.

2. The system of claim 1, wherein the feeding glove being made of a latex material.

3. The system of claim 1, wherein the feeding glove being non-disposable.

4. The system of claim 1, wherein the plurality of tubes being four (4) in number.

5. The system of claim 1, wherein the tubes being hollow.

6. The system of claim 1, wherein the tubing assembly being disposable.

7. The system of claim 1, wherein the valve being a pressure valve.

8. The system of claim 1, wherein the animals being one or more puppies.

9. The system of claim 1, wherein the animals being one or more kittens.

10. The system of claim 1, wherein feeding container being a feeding bag.

11. A method for a feeding system for assisting young animals in nursing and feeding, the method comprising:
placing a hand in a feeding glove;
placing each of a plurality of tubes in a finger channel of the feeding glove;
pouring a liquid nutrient into the feeding container;
inserting one or more finger channels of the feeding glove into a mouth of a young animal;
actuate the valve using pressure from the finger on one or more of the tubes;
releasing the liquid nutrient into a distributing tube from the feeding container; and
de-actuation of the valve releasing pressure from the one or more tubes, wherein the liquid nutrient being stopped from entering the.

12. The method of claim 1, wherein the feeding glove being made of a latex material.

13. The method of claim 1, wherein the feeding glove being non-disposable.

14. The method of claim 1, wherein the plurality of tubes being four (4) in number.

15. The method of claim 1, wherein the tubes being hollow.

16. The method of claim 1, wherein the tubing assembly being disposable.

17. The method of claim 1, wherein the valve being a pressure valve.

18. The method of claim 1, wherein the animals being one or more puppies.

19. The method of claim 1, wherein the animals being one or more kittens.

20. The method of claim 1, wherein feeding container being a feeding bag.
